(19) United States
(12) Patent Application Publication
(10) Pub. No.: US 2013/0132270 A1
(43) Pub. Date: May 23, 2013

(54) CHARGING STATIONS INFORMATION CONTROL SYSTEM AND METHOD FOR ELECTRIC VEHICLES

(71) Applicants: HO-LEUNG CHEUNG, Santa Clara, CA (US); JIA-LIN CHEN, Tu-Cheng (TW); CHUN-WEN WANG, Tu-Cheng (TW); CHIA-HUNG CHIEN, Tu-Cheng (TW)

(72) Inventors: HO-LEUNG CHEUNG, Santa Clara, CA (US); JIA-LIN CHEN, Tu-Cheng (TW); CHUN-WEN WANG, Tu-Cheng (TW); CHIA-HUNG CHIEN, Tu-Cheng (TW)

(73) Assignee: HON HAI PRECISION INDUSTRY CO., LTD., Tu-Cheng (TW)

(21) Appl. No.: 13/340,650

(22) Filed: Dec. 29, 2011

(30) Foreign Application Priority Data
Nov. 17, 2011 (TW) 100142143

(51) Int. Cl. G06Q 20/22; G08G 1/123; H02J 7/00

(52) U.S. Cl. 705/39; 320/106; 340/996; 705/35

(57) ABSTRACT

A charging station information control system is provided. The charging station information control system includes at least one processor. A plurality of modules to be executed by the at least one processor includes an information acquiring module and a matching module. The information acquiring module acquires positional information of an electric vehicle. A matching module determines one or more suitable charging stations whose positional information matches the acquired positional information of the electric vehicle, and acquires the positional information of the one or more suitable charging stations.

### BACKGROUND

1. Technical Field

The present disclosure relates to charging station information control systems and, particularly, to a charging station information control system and a method for an electric vehicle.

2. Description of Related Art

Electric vehicles are more and more found on the road. However, a driver of an electric car often faces the challenge to find a nearby charging station to charge the vehicle. Therefore, people who wish to drive their electric vehicle for a long trip risk running out of power and not being able to find a nearby charging station along the route when in need.

Therefore, what is needed is a charging station information control system and a method for an electric vehicle to overcome the described limitations.

### BRIEF DESCRIPTION OF THE DRAWINGS

FIG. 1 is a schematic diagram of a charging station information control system, including an electric vehicle, a control center, and a number of charging stations, in accordance with an exemplary embodiment.

FIG. 2 is a block diagram of the hardware infrastructure of the charging station information control system for the electric vehicle of FIG. 1, in accordance with an exemplary embodiment.

FIG. 3 is a flowchart of a charging station information control method implemented by the charging station information control system of FIG. 2, in accordance with an exemplary embodiment.

### DETAILED DESCRIPTION

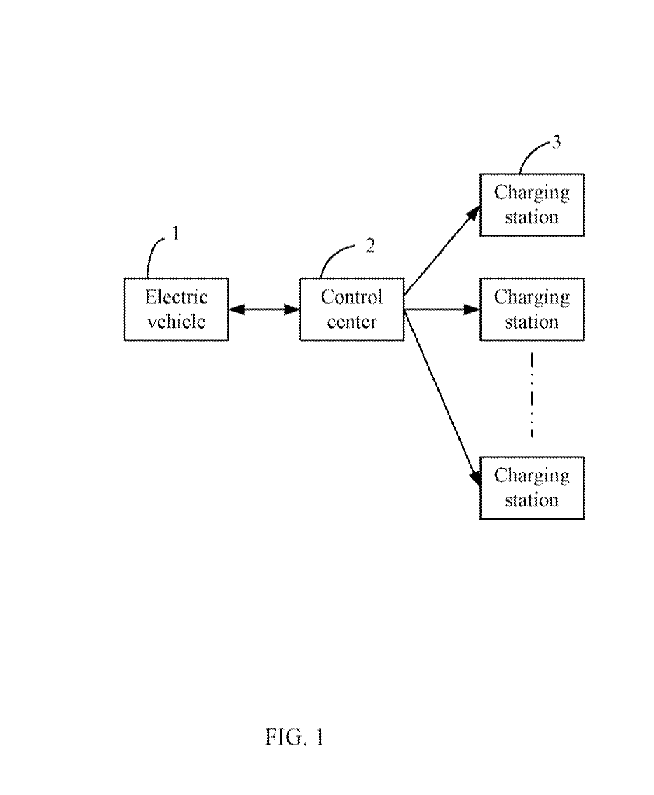

FIG. 1 shows a charging station information control system 10 for an electric vehicle 1 which is applied in a hardware environment which includes a control center 2, at least one electric vehicle 1 and a number of charging stations 3 in different places. The electric vehicle 1 and the charging stations 3 are connected to the control center 2 by a network connection. The control center 2 provides information about the charging stations 3 in the different places including information as to the location of each charging station 3 (positional information).

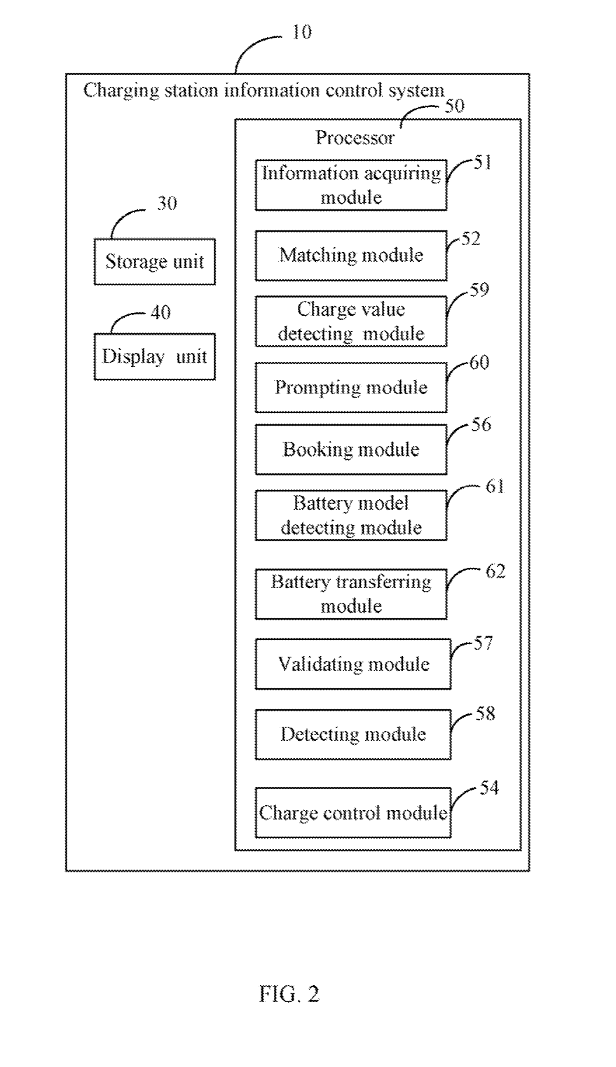

Referring to FIG. 2, the charging station information control system 10 includes at least one processor 50. A plurality of modules to be executed by the at least one processor 50 includes an information acquiring module 51 and a matching module 52. The information acquiring module 51, which can be invoked/implemented by the at least one processor 50 to acquire current positional information of the electric vehicle 1. The matching module 52 which can be invoked/implemented by the at least one processor 50 to determine one or more charging stations 3 which are suitable or expedient for the electric vehicle 1 according to the current positional information of the electric vehicle 1 and the positional information of the charging stations 3, and acquires the positional information of the one or more suitable charging stations 3.

In a first embodiment, the information acquiring module 51 is incorporated into the electric vehicle 1 and the matching module 52 is incorporated into the control center 2. In other embodiments, the information acquiring module 51 and the matching module 52 can both be incorporated into the electric vehicle 1 or into the control center 2.

The information acquiring module 51 which can be invoked/implemented by the at least one processor 50 to further acquire a current route of the electric vehicle 1. The matching module 52 which can be invoked/implemented by the at least one processor 50 to further select at least one charging station 3 whose positional information is along the route of the electric vehicle 1 from the one or more suitable charging stations 3, and acquires the positional information of the selected charging station 3.

Furthermore, the information acquiring module 51 which can be invoked/implemented by the at least one processor 50 to acquire a current state of electrical charge available (charge value) of the electric vehicle 1. A plurality of modules to be executed by the at least one processor 50 further includes a charge value detecting module 59, a prompting module 60, and a booking module 56. The charge value detecting module 59 which can be invoked/implemented by the at least one processor 50 to detect whether the current charge value of the electric vehicle 1 is sufficient for the whole journey. The prompting module 60 which can be invoked/implemented by the at least one processor 50 to determine that the current charge value of the electric vehicle 1 is not sufficient and may book a charging station 3 for the electric vehicle 1 when the current charge value of the electric vehicle 1 is not sufficient. The booking module 56 which can be invoked/implemented by the at least one processor 50 to attempt to book a charging station 3 for the electric vehicle 1 when the user of the electric vehicle 1 selects one of the charging stations 3.

Furthermore, the information concerning the charging station 3 includes information as to batteries or other energy storage devices which can be accommodated by each of the charging stations 3 (battery model information). When the booking module 56 which can be invoked/implemented by the at least one processor 50 to book the charging station 3 for the electric vehicle 1, the information acquiring module 51 which can be invoked/implemented by the at least one processor 50 to further acquire information as to the nature or type of battery or other energy storage device fitted in the electric vehicle 1 (battery model information). A plurality of modules to be executed by the at least one processor 50 further includes a battery model detecting module 61 and a battery transferring module 62. The battery model detecting module 61 which can be invoked/implemented by the at least one processor 50 to seek to detect compatibility between the battery model information regarding the booked charging station 3 and the battery model information regarding the electric vehicle 1. The battery transferring module 62 which can be invoked/implemented by the at least one processor 50 to generate an instruction to the user to transfer batteries or other energy devices whose battery model information is compatible with battery model information regarding the electric vehicle 1 from other charging stations 3 when the battery model information regarding the booked charging station 3 is not compatible with the battery model information regarding the electric vehicle 1.

A plurality of modules to be executed by the at least one processor 50 further includes a validating module 57. The charging station information control system further includes a storage unit 30. The storage unit 30 stores a number of items of predetermined validation information of the user of the electric vehicles 1. When booking the charging station 3 for the electric vehicle 1, the information acquiring module 51 which can be invoked/implemented by the at least one processor 50 to further acquire setting information and validation information of the electric vehicle 1. The setting information of the electric vehicle 1 is a license number of the electric vehicle 1. The validating module 57 which can be invoked/implemented by the at least one processor 50 to validate whether the acquired validation information of the electric vehicle 1 matches one of the items of the predetermined validation information of the electric vehicles 1 in the storage unit 30. The booking module 56 which can be invoked/implemented by the at least one processor 50 to book the charging station 3 for the electric vehicle 1 when the validation information of the electric vehicle 1 matches one of the items of the predetermined validation information of the electric vehicles 1 in the storage unit 30. In one embodiment, an item of predetermined validation information may incorporate the fingerprint of a user, for example, another item may include an image of the user's eye, another item may be the sound of a user's voice, and another item may incorporate a combination of the foregoing, or other identifying characteristic(s).

Furthermore, a plurality of modules to be executed by the at least one processor 50 further includes a detecting module 58 and a charge control module 54. When the electric vehicle 1 arrives at the charging station 3, the detecting module 58 which can be invoked/implemented by the at least one processor 50 to detect whether the setting information of the arrived electric vehicle 1 is consistent with the setting information of the electric vehicle 1 acquired by the information acquiring module 51 when the charging station 3 was booked. If yes, the charge control module 54 which can be invoked/implemented by the at least one processor 50 to control the charging station 3 to allow energy charging to the arrived electric vehicle 1, otherwise, the charge control module 54 which can be invoked/implemented by the at least one processor 50 to control the charging station 3 to withhold energy charging to the arrived electric vehicle 1.

Furthermore, the storage unit 30 further stores a number of payment accounts. The charging station information control system 10 further includes a display unit 40. When the charge station 3 is booked by the electric vehicle 1, the information acquiring module 51 which can be invoked/implemented by the at least one processor 50 to acquire the payment account which is associated with the electric vehicle 1, determine the amount of money available in the acquired payment account, and display the amount available on the display unit 40, thereby helping the user to understand whether there is enough money in the payment account for the user to pay for an energy charge for the electric vehicle 1.

Furthermore, the charge control module 54 which can be invoked/implemented by the at least one processor 50 to deduct a payment charge from the payment account after the electric vehicle 1 has been completely charged. Therein, each charging station 3 is registered as a credit supplier.

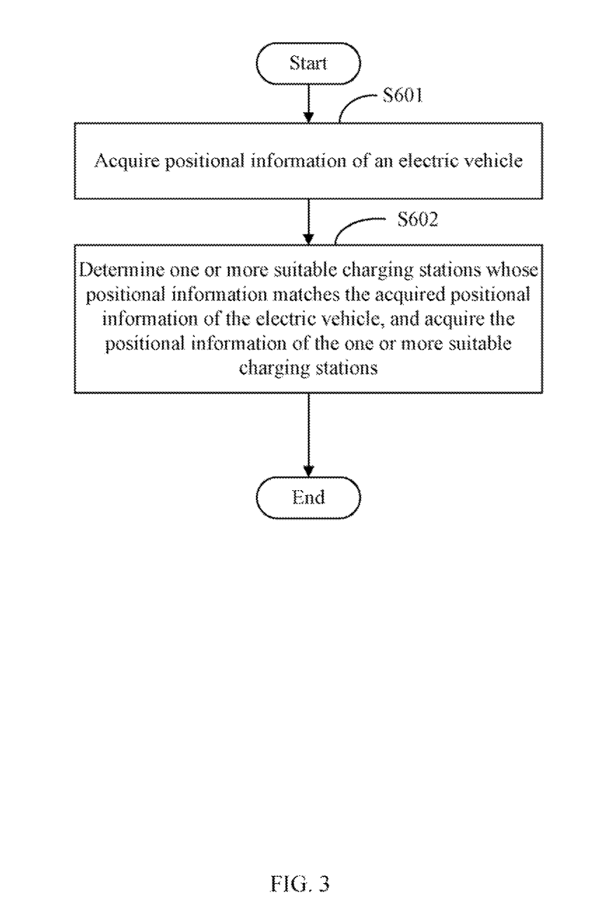

FIG. 3 is a flowchart of a charging station information control method implemented by the charging station information control system of FIG. 2, in accordance with an exemplary embodiment.

In step S601, the information acquiring module 51 which can be invoked/implemented by the at least one processor 50 to acquire current positional information relating to the electric vehicle 1.

In step S602, the matching module 52 which can be invoked/implemented by the at least one processor 50 to determine one or more suitable charging stations 3 according to the current positional information of the electric vehicle 1 and the positional information of the charging stations 3, and acquire the positional information of the one or more suitable charging stations 3.

The method further includes the following steps: the information acquiring module 51 which can be invoked/implemented by the at least one processor 50 to acquire a current route of the electric vehicle 1; the matching module 52 which can be invoked/implemented by the at least one processor 50 to select at least one charging station 3 whose positional information is along the route of the electric vehicle 1 from the one or more suitable charging stations 3, and acquire the positional information of the particular charging station 3 which is selected.

The method further includes the following steps: the information acquiring module 51 which can be invoked/implemented by the at least one processor 50 to acquire a charge value of the electric vehicle 1, the charge value detecting module 59 which can be invoked/implemented by the at least one processor 50 to detect whether the charging value of the electric vehicle 1 is sufficient for the whole journey, the prompting module 60 which can be invoked/implemented by the at least one processor 50 to issue a warning if the charge value of the electric vehicle 1 is not sufficient for the whole journey and invites confirmation that a charging station 3 for the electric vehicle 1 should be booked by allowing the user of the electric vehicle 1 to select a charging station 3 to be booked. After the charging station 3 has been booked by the electric vehicle 1, the information acquiring module 51 which can be invoked/implemented by the at least one processor 50 to further acquire the battery model information of the battery in the electric vehicle 1, and the battery model detecting module 61 which can be invoked/implemented by the at least one processor 50 to detect whether the battery model information of the booked charging station 3 is compatible with the battery model information regarding the electric vehicle 1. The battery transferring module 62 which can be invoked/implemented by the at least one processor 50 to generate an instruction to the user to transfer batteries or other energy devices whose battery model information is compatible with battery model information regarding the electric vehicle 1 from other charging stations 3 when the battery model information regarding the booked charging station 3 is not compatible with the battery model information regarding the electric vehicle 1. After the electric vehicle 1 arrives at the charging station 3, the detecting module 58 which can be invoked/implemented by the at least one processor 50 to detect whether the setting information of the arrived electric vehicle 1 is consistent with the setting information of the electric vehicle 1 acquired by the information acquiring module 51 when the charging station 3 was booked, if yes, the charge control module 54 controls the charging station 3 to allow an energy charge the arrived electric vehicle 1, otherwise, the charge control module 54 which can be invoked/implemented by the at least one processor 50 to control the charging station 3 to withhold an energy charge from the arrived electric vehicle 1. After the electric vehicle 1 has been completely charged, the charge control module 54 which can be invoked/implemented by the at least one processor 50 to deduct a payment charge from the payment account.

The method for booking the charging station 3 further includes the following steps: the information acquiring module 51 which can be invoked/implemented by the at least one processor 50 to further acquire setting information and validation information of the electric vehicle 1, the validating module 57 which can be invoked/implemented by the at least one processor 50 to validate whether the acquired validation information of the electric vehicle 1 matches one of the items of the predetermined validation information of the electric vehicles 1 in the storage unit 30, the booking module 56 which can be invoked/implemented by the at least one processor 50 to book the charging station 3 for the electric vehicle 1 when the validation information of the electric vehicle 1 matches one of the items of the predetermined validation information of the electric vehicles 1 in the storage unit 30.

After the charge station 3 has been booked, the further steps of the method are: the information acquiring module 51 which can be invoked/implemented by the at least one processor 50 to acquire the payment account associated with the user or with the electric vehicle 1, determine the amount of money available in the acquired payment account, and display the amount of available money on the display unit 40.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A charging station information control system comprising:
at least one processor;
a plurality of modules to be executed by the at least one processor, wherein the plurality of modules comprise:
an information acquiring module configured to acquire positional information of a vehicle; and
a matching module configured to determine one or more suitable charging stations whose positional information matches the acquired positional information of the vehicle, and acquire the positional information of the one or more suitable charging stations.

2. The charging station information control system as described in claim 1, wherein the information acquiring module is further configured to acquire a current route of the vehicle, and the matching module is further configured to select at least one charging station whose positional information is along the route of the vehicle from the one or more charging stations, and acquire the positional information of the selected charging station.

3. The charging station information control system as described in claim 1, wherein a plurality of modules to be executed by the at least one processor further comprises:
the information acquiring module further configured to acquire a charge value of the vehicle;
a charge value detecting module configured to detect whether the current charge value of the vehicle is sufficient for a whole journey;
a prompting module configured to prompt that the charge value of the vehicle is not sufficient and to book a charging station for the vehicle when the charge value of the vehicle is not sufficient for the whole journey; and
a booking module configured to book a charging station for the vehicle when a user of the vehicle selects one of the charging stations.

4. The charging station information control system as described in claim 3, wherein a plurality of modules to be executed by the at least one processor further comprises:
the information acquiring module is further configured to acquire battery model information of the batteries fitted in the vehicle when the booking module books the charging station for the vehicle;
a battery model detecting module configured to detect whether that battery model information accommodated by the charging station is compatible with the battery model information fitted in the vehicle; and
a battery transferring module configured to generate an instruction to the user to transfer batteries whose battery model information is compatible with battery model information fitted in the vehicle from other charging stations when the battery model information accommodated by the charging station is not compatible with the battery model information fitted in the vehicle.

5. The charging station information control system as described in claim 4, further comprising a storage unit for storing a plurality of items of predetermined validation information of user of the vehicles, wherein a plurality of modules to be executed by the at least one processor further comprises:
the information acquiring module further configured to acquire setting information and validation information of the vehicle when the booking module books the charging station for the vehicle;
a validating module configured to validate whether the acquired validation information of the vehicle matches one of the items of the predetermined validation information of the vehicles in the storage unit; and
the booking module books the charging station for the vehicle when the acquired validation information of the vehicle matches one of the items of the predetermined validation information of the vehicles.

6. The charging station information control system as described in claim 5, further comprising a display unit, wherein the storage unit is further configured to store a plurality of payment accounts associated with one of the vehicles, a plurality of modules to be executed by the at least one processor further comprises:
the information acquiring module further configured to acquire the payment account associated with the vehicle, determine the amount of money available in the acquired payment account, and display the amount available on the display unit.

7. The charging station information control system as described in claim 5, wherein the predetermined validation information is a fingerprint of a user, an image of a user's eye, or a combination thereof.

8. The charging station information control system as described in claim 5, wherein a plurality of modules to be executed by the at least one processor further comprises:
when the vehicle arrives at the booked charging station, a detecting module configured to detect whether the setting information of the arrived vehicle is consistent with the setting information of the vehicle acquired by the information acquiring module when the charging station was booked; and
a charge control module configured to control the booked charging station to charge the vehicle when the setting information of the arrived vehicle is consistent with the setting information of the vehicle acquired by the information acquiring module.

9. The charging station information control system as described in claim 5, wherein the setting information of the vehicle is a license number of the vehicle.

10. The charging station information control system as described in claim 8, wherein the charge control module is further configured to deduct a payment charge from the payment account associated with the vehicle after the vehicle has been completely charged.

11. A charging station information control system comprising:
a vehicle comprising at least one processor;
a plurality of modules to be executed by the at least one processor, wherein the plurality of module comprises:
an information acquiring module configured to provide positional information of the vehicle; and
a matching module configured to determine one or more suitable charging stations whose positional information matches the acquired positional information of the vehicle, and acquire the positional information of the one or more suitable charging stations.

12. A charging station information control method implemented by a charging station system which comprises at least one processor to execute a plurality of steps, wherein the plurality of steps comprises:
acquiring positional information of a vehicle; and
determining one or more suitable charging stations whose positional information matches the acquired positional information of the vehicle, and acquiring the positional information of the one or more suitable charging stations.

13. The charging station information control method as described in claim 12, further comprising:
acquiring a current route of the vehicle;
selecting at least one charging station whose positional information is along the route of the vehicle from the one or more suitable charging stations, and acquiring the positional information of the selected charging station.

14. The charging station information control method as described in claim 12, further comprising:
acquiring a charge value of the vehicle;
detecting whether the charge value of the vehicle is sufficient;
prompting that the charge value of the vehicle is not sufficient and to book a charging station for the vehicle when the current charge value of the vehicle is not sufficient; and
booking a charging station for the vehicle when a user of the vehicle selects one of the charging stations.

15. The charging station information control method as described in claim 14, further comprising:
acquiring battery model information of the batteries fitted in the vehicle when booking the charging station for the vehicle;
detecting whether that the battery model information accommodated by the charging station is compatible with the battery model information fitted in the vehicle; and
generating an instruction to the user to transfer batteries whose battery model information is compatible with battery model information fitted in the vehicle from other charging stations when the battery model information accommodated by the charging station is not compatible with the battery model information fitted in the vehicle.

16. The charging station information control method as described in claim 15, wherein the control center further comprises a storage unit for storing a plurality of items of predetermined validation information of user of the vehicles, the method comprising:
acquiring setting information and validation information of the vehicle when booking the charging station for the vehicle;
validating whether the acquired validation information of the vehicle matches one of the items of the predetermined validation information of the vehicles; and
booking the charging station for the vehicle when the acquired validation information of the vehicle matches one of the items of the predetermined validation information of the vehicles.

17. The charging station information control method as described in claim 16, wherein the control center further comprises a display unit, the storage unit is further configured to store a plurality of payment accounts associated with one of the vehicles, the method comprising:
acquiring the payment account associated with the vehicle, determining the amount of money available in the acquired payment account, and displaying the amount available on the display unit.

18. The charging station information control method as described in claim 16, wherein the predetermined validation information is a fingerprint of a user, an image of a user's eye, or a combination thereof.

19. The charging station information control method as described in claim 16, further comprising:
detecting whether the setting information of the arrived vehicle is consistent with the acquired setting information of the vehicle when the charging station was booked; and
controlling the booked charging station to charge the vehicle when the setting information of the arrived vehicle is consistent with the acquired setting information of the vehicle when the charging station was booked.

20. The charging station information control method as described in claim 16, wherein the setting information of the vehicle is a license number of the vehicle.

21. The charging station information control method as described in claim 19, further comprising:
deducting a payment charge from the payment account associated with the vehicle after the vehicle has been completely charged.
